(19) United States
(12) Patent Application Publication
(10) Pub. No.: US 2021/0094555 A1
(43) Pub. Date: Apr. 1, 2021

(54) VEHICULAR COLLISION AVOIDANCE SYSTEM USING ADAPTIVE FILTERING OF VEHICLE SPEED

(71) Applicant: Magna Electronics Inc., Auburn Hills, MI (US)

(72) Inventor: Devendra Bajpai, Bloomfield Hills, MI (US)

(21) Appl. No.: 16/948,624

(22) Filed: Sep. 25, 2020

Related U.S. Application Data
(60) Provisional application No. 62/906,313, filed on Sep. 26, 2019.

(51) Int. Cl. B60W 40/105; B60W 30/14; B60W 30/165

(52) U.S. Cl. CPC B60W 40/105; B60W 30/143; B60W 2520/28; B60W 2422/70; B60W 2520/105; B60W 30/165

(57) ABSTRACT

A vehicular driving assist system includes a plurality of vehicle speed sensors disposed at a vehicle, with each of the vehicle speed sensors generating an output representative of a respective sensed or estimated speed of the vehicle. A control includes circuitry and associated software. The circuitry of the control includes a processor for processing outputs of the plurality of vehicle speed sensors to determine a current speed of the vehicle. The control uses a multi-sensor filter to determine a single filtered current vehicle speed based on the outputs of the vehicle speed sensors.

### CROSS REFERENCE TO RELATED APPLICATION

The present application claims priority of U.S. provisional application Ser. No. 62/906,313, filed Sep. 26, 2019, which is hereby incorporated herein by reference in its entirety.

### FIELD OF THE INVENTION

The present invention relates generally to a vehicle vision system for a vehicle and, more particularly, to a vehicle vision system that utilizes one or more cameras at a vehicle.

### BACKGROUND OF THE INVENTION

Use of imaging sensors in vehicle imaging systems is common and known. Examples of such known systems are described in U.S. Pat. Nos. 5,949,331; 5,670,935 and/or 5,550,677, which are hereby incorporated herein by reference in their entireties.

### SUMMARY OF THE INVENTION

The present invention provides a driver assistance system for a vehicle that utilizes one or more sensors to capture sensor data. The driver assist system for the vehicle includes a plurality of vehicle speed sensors disposed at a vehicle, and each of the vehicle speed sensors estimate or sense or determine a current speed of the vehicle (i.e., each sensor generates an output that is indicate of the speed sensed by that sensor and the output is processed to determine the vehicle speed according to that sensor). The plurality of vehicle speed sensors may include at least two selected from the group consisting of (i) at least one vehicle wheel angular velocity sensor of a driven vehicle wheel of the vehicle, (ii) at least one vehicle wheel angular velocity sensor of a non-driven vehicle wheel of the vehicle, (iii) at least one inertial measurement unit of the vehicle and (iv) at least one GPS sensor of the vehicle. The system also includes a control comprising circuitry and associated software and the circuitry of the control includes a processor for processing sensor data captured by the plurality of vehicle speed sensors to determine a current speed of the vehicle. The control uses a multi-sensor filter to determine a single filtered vehicle speed based on the sensor data of each of the vehicle speed sensors.

These and other objects, advantages, purposes and features of the present invention will become apparent upon review of the following specification in conjunction with the drawings.

### BRIEF DESCRIPTION OF THE DRAWINGS

FIG. 1 is a plan view of a vehicle with a vision system that incorporates sensors in accordance with the present invention;

FIG. 2 is a plan view of a host vehicle following a target vehicle;

FIG. 3 is a plan view of the host vehicle following the target vehicle and experiencing a braking event;

FIG. 4 is a plan view of the host vehicle following the target vehicle with brakes released due to error in velocity computation;

FIG. 5 is a graph of wheel angular velocity based vehicle velocity with a strong braking event;

FIG. 6 is a graph of vehicle acceleration and longitudinal acceleration with a strong braking event;

FIG. 7 is a graph of average velocity for driven and non-driven wheels of a vehicle;

FIG. 8 is a block diagram of a multi-sensor filter in accordance with the present invention;

FIG. 9 is another block diagram of the multi-sensor filter in accordance with the present invention;

FIG. 10 is a graph of the multi-filter output with low sensor noise;

FIG. 11 is a graph of the multi-filter output with medium sensor noise; and

FIG. 12 is another graph of the multi-filter output with fused sensors.

### DESCRIPTION OF THE PREFERRED EMBODIMENTS

A vehicle driver assist system and/or object detection system and/or alert system operates to capture images exterior of the vehicle and may process the captured image data to display images and to detect objects at or near the vehicle and in the predicted path of the vehicle, such as to assist a driver of the vehicle in maneuvering the vehicle in a rearward direction. The vision system includes an image processor or image processing system that is operable to receive image data from one or more cameras and provide an output to a display device for displaying images representative of the captured image data. Optionally, the vision system may provide display, such as a rearview display or a top down or bird's eye or surround view display or the like.

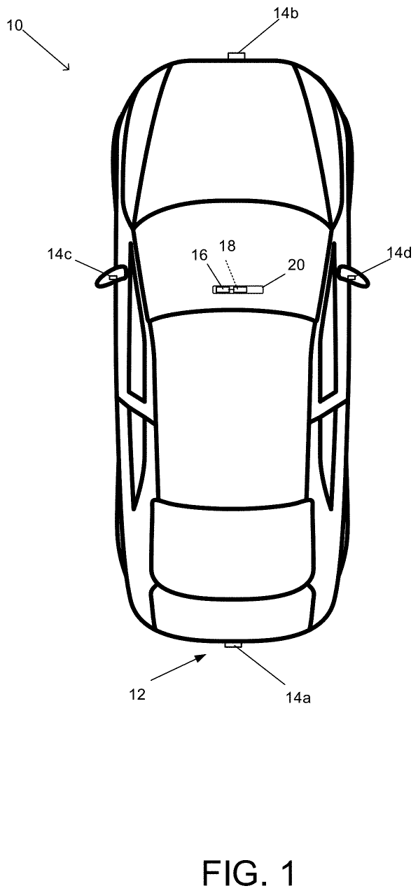

Referring now to the drawings and the illustrative embodiments depicted therein, a vehicle 10 includes an imaging system or vision system 12 that includes at least one exterior viewing imaging sensor or camera, such as a rearward viewing imaging sensor or camera 14a (and the system may optionally include multiple exterior viewing imaging sensors or cameras, such as a forward viewing camera 14b at the front (or at the windshield) of the vehicle, and a sideward/rearward viewing camera 14c, 14d at respective sides of the vehicle), which captures images exterior of the vehicle, with the camera having a lens for focusing images at or onto an imaging array or imaging plane or imager of the camera (FIG. 1). Optionally, a forward viewing camera may be disposed at the windshield of the vehicle and view through the windshield and forward of the vehicle, such as for a machine vision system (such as for traffic sign recognition, headlamp control, pedestrian detection, collision avoidance, lane marker detection and/or the like). The vision system 12 includes a control or electronic control unit (ECU) or processor 18 that is operable to process image data captured by the camera or cameras and may detect objects or the like and/or provide displayed images at a display device 16 for viewing by the driver of the vehicle (although shown in FIG. 1 as being part of or incorporated in or at an interior rearview mirror assembly 20 of the vehicle, the control and/or the display device may be disposed elsewhere at or in the vehicle). The data transfer or signal communication from the camera to the ECU may comprise any suitable data or communication link, such as a vehicle network bus or the like of the equipped vehicle.

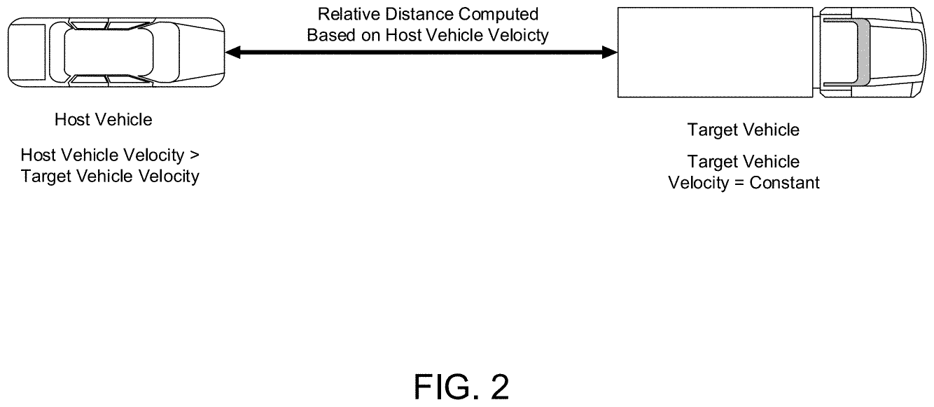

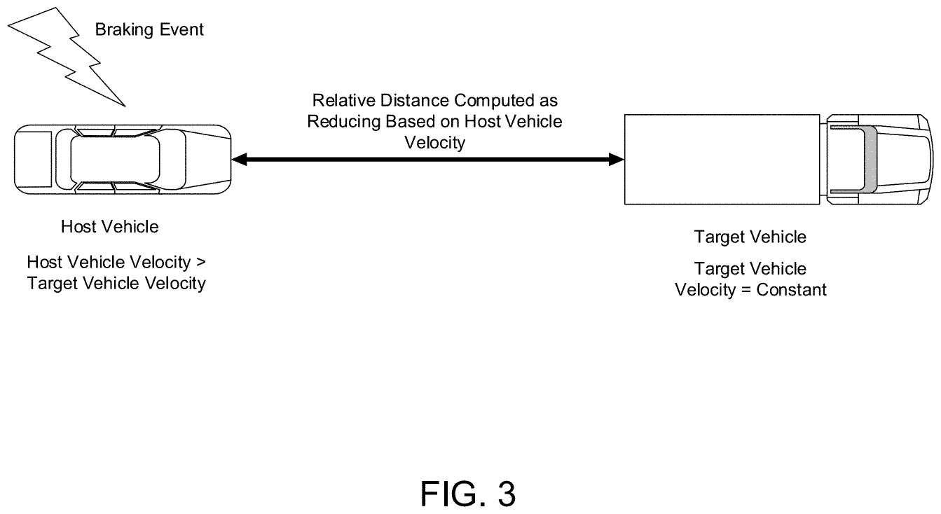

Collision Warning Systems and Automatic Emergency Braking Systems (AEB systems) are important vehicle safety features. Typically vehicle speed is used to compute a relative distance between a host vehicle and a vehicle in front of the host vehicle (FIG. 2). The vehicle speed is generally computed using an average of revolutions per minute of driven and/or non-driven wheels. However, during intense braking events (e.g., driver induced, AEB system braking, etc.) one or more wheels may lock up and/or spin due to road (e.g., ice) or tire conditions (FIG. 3). This causes an erroneous average vehicle speed computation as the wheel revolution rate is no longer consistent with the actual vehicle speed. For example, the wheel spinning on ice could cause an erroneous average vehicle speed that is too high while the wheel locking from a braking event could cause an erroneous average vehicle speed that is too low.

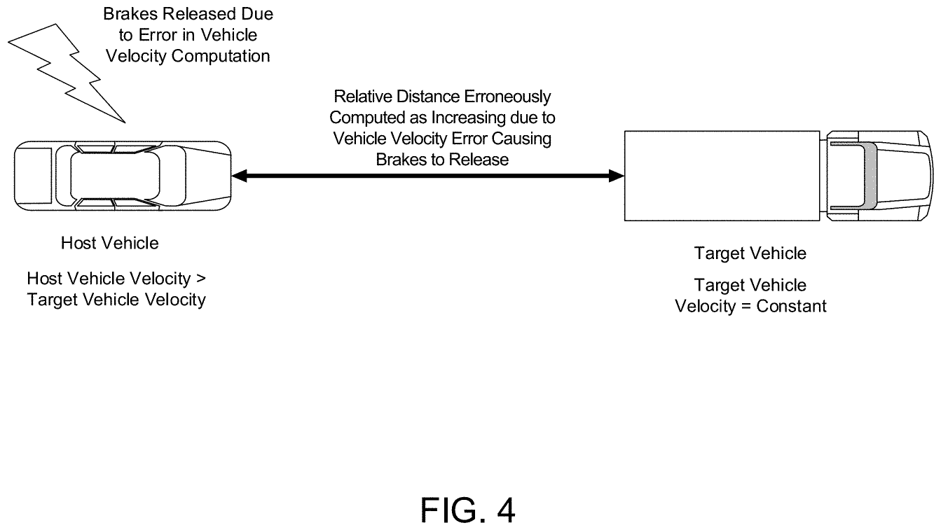

The vehicle speed error then in turn causes error in the relative distance computation (i.e., the distance between the host vehicle and the target vehicle) (FIG. 4) as the relative distance computation is dependent upon an accurate vehicle speed. In FIG. 4, a strong braking event caused the wheel to lock up, causing an erroneously low vehicle speed calculation. Because the system believes the vehicle is now travelling slower than the vehicle in front, the brakes are erroneously released.

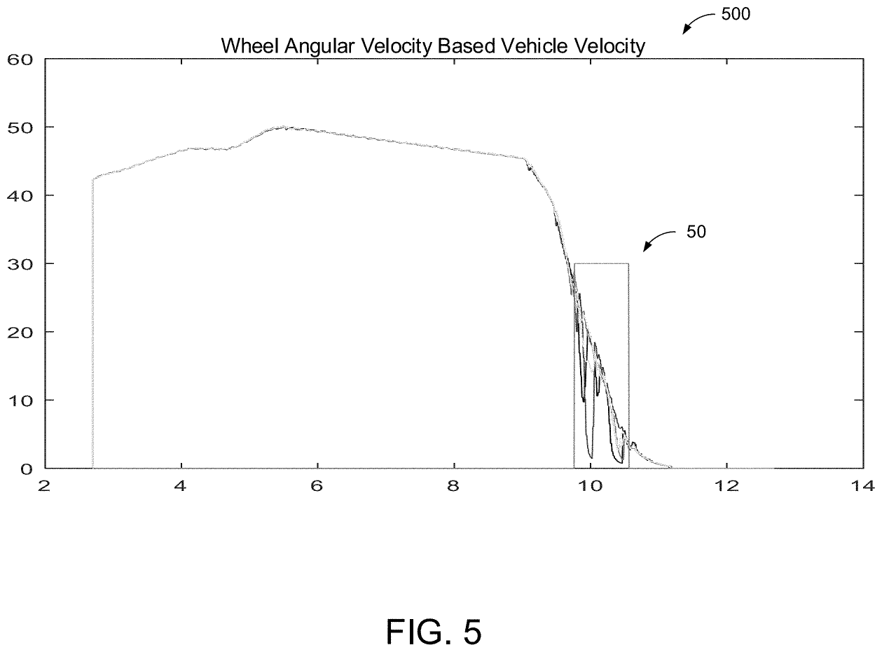

FIG. 5 illustrates a graph 500 of measured angular velocity of a wheel of the vehicle that includes a strong braking event. At area 50, during the strong braking event, the measured angular velocity of the wheel becomes erratic which causes erroneous average velocity computation. For example, there are extreme dips where the wheel angular velocity briefly but significantly drops. This may cause the brakes to be released, which is dangerous and risks causing an accident or other unexpected or undesired behavior. In some implementations, a multi-sensor filtering method and/or system eliminates vehicle speed errors caused due to hard braking-wheel locking conditions and other causes of erroneous vehicle speed calculations.

The system may collect vehicle speed sensor data from a variety of sensors. For example, the controller may collect sensor data (e.g., via a CAN bus) from one, two, or more vehicle speed sensors to measure angular velocity from driven wheels and/or non-driven wheel. The controller may also receive vehicle acceleration signals from one or more accelerometers and/or from an inertial measurement unit (IMU). The controller may also receive vehicle speed estimation from a global positioning system (GPS) and/or navigation system of the vehicle. Sensor fusion techniques may be used to filter out noise and inaccuracies from one or more inputs. As some sensors may be more accurate and less noisy than other sensors, each sensor may be weighted accordingly. The sensor weights may be based on sensor accuracy and/or noise in the outputs of the sensors. For example, a sensor that is more accurate (such as historically more accurate or presumed or selected or determined as being more accurate, such as by a rating of each of the sensors by the system developer or manufacturer) and/or less noisy may be given a higher or larger or heavier weight (i.e., its output is emphasized more in the determination or estimation of the current vehicle speed). That is, a sensor that is determined or presumed to be the most accurate and/or the least noisy may be given the greatest weight while a sensor that is determined or presumed to be the least accurate and/or the noisiest may be given the least weight. The weight may determine an amount of the overall effect the sensor has on the determined or estimated vehicle speed. The greater or heavier the weight, the more impact the respective sensor may have on the final vehicle speed. Implementations herein estimate vehicle speed using multiple sensors and multiple techniques to output a single speed estimate using sensor data fusion.

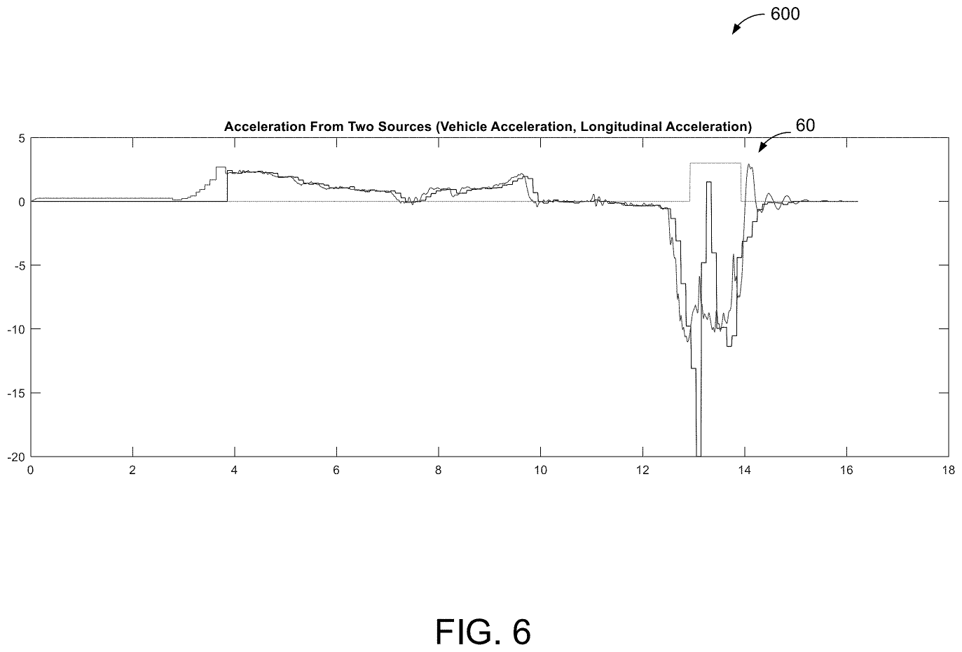

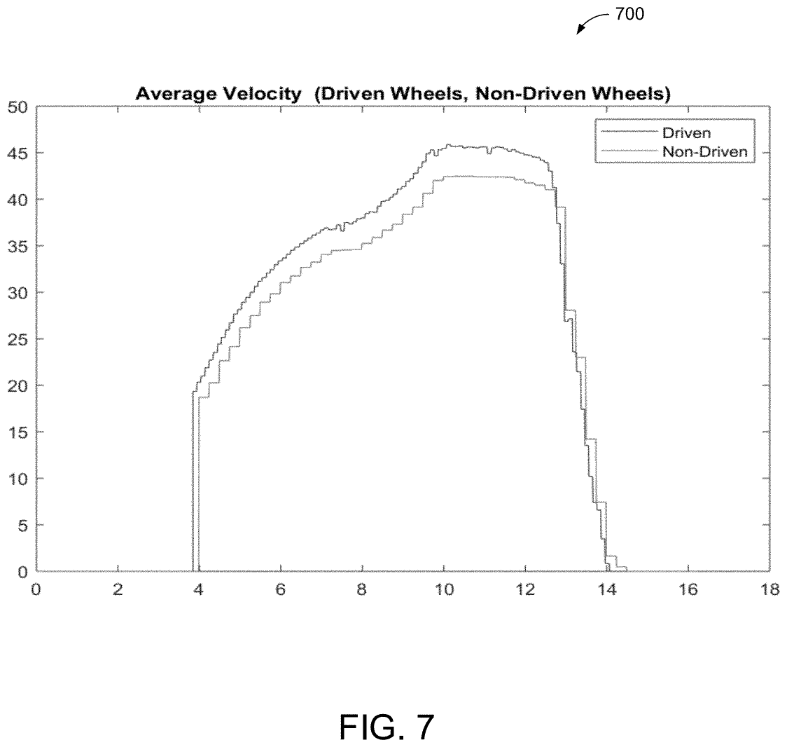

Referring now to FIG. 6, a graph 600 illustrates measured acceleration from two sources (i.e., two separate sensors) that measure vehicle acceleration and longitudinal acceleration respectively. For example, the sources may be an accelerometer and an IMU. At area 60, a strong braking event causes each sensor to measure acceleration erratically, which may cause erroneous average velocity computation that are based on the measurements. FIG. 7 illustrates a graph 700 of average velocity measured from sensors of driven and non-driven wheels. Here, the vehicle velocity obtained from the driven and non-driven wheels is different which may cause erroneous average velocity computation.

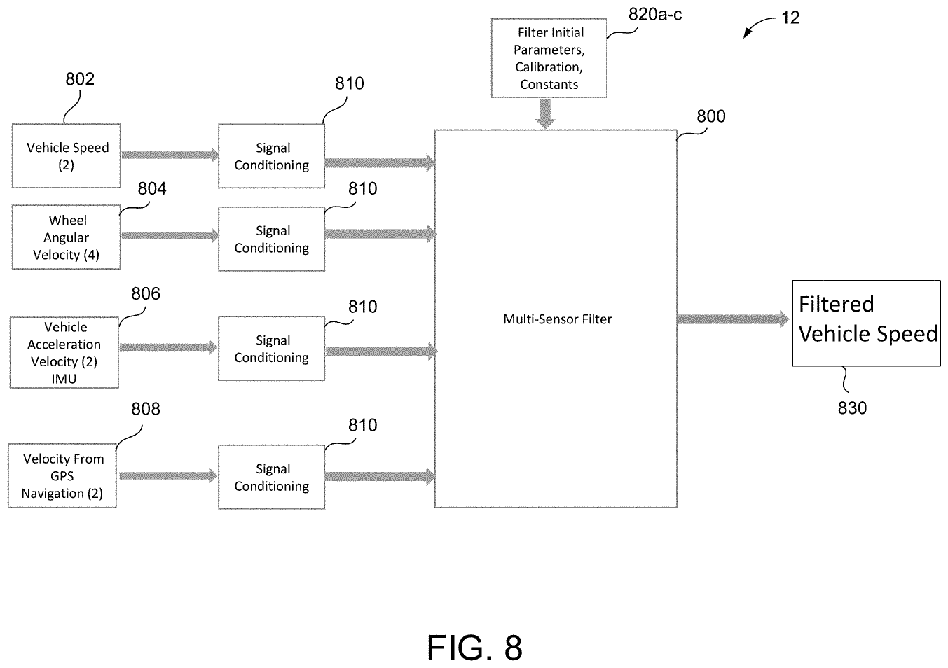

Referring now to FIG. 8, the system 12 includes a multi-sensor filter 800. The multi-sensor filter receives velocity data from one or more (e.g., two) vehicle speed sensors 802, one or more (e.g., four) wheel angular velocity sensors 804, one or more (e.g., two) vehicle acceleration velocity IMU sensors, and one or more (e.g., two) GPS navigation sensors 808. Each data input may undergo signal conditioning 810 before the multi-sensor filter receives the data (e.g., smoothing or filtering the signal). The multi-sensor filter 800, in some examples, also receives initial filter parameters 820a, calibration parameters 820b, and/or constants 820c. The multi-sensor filter outputs a filtered vehicle speed 830.

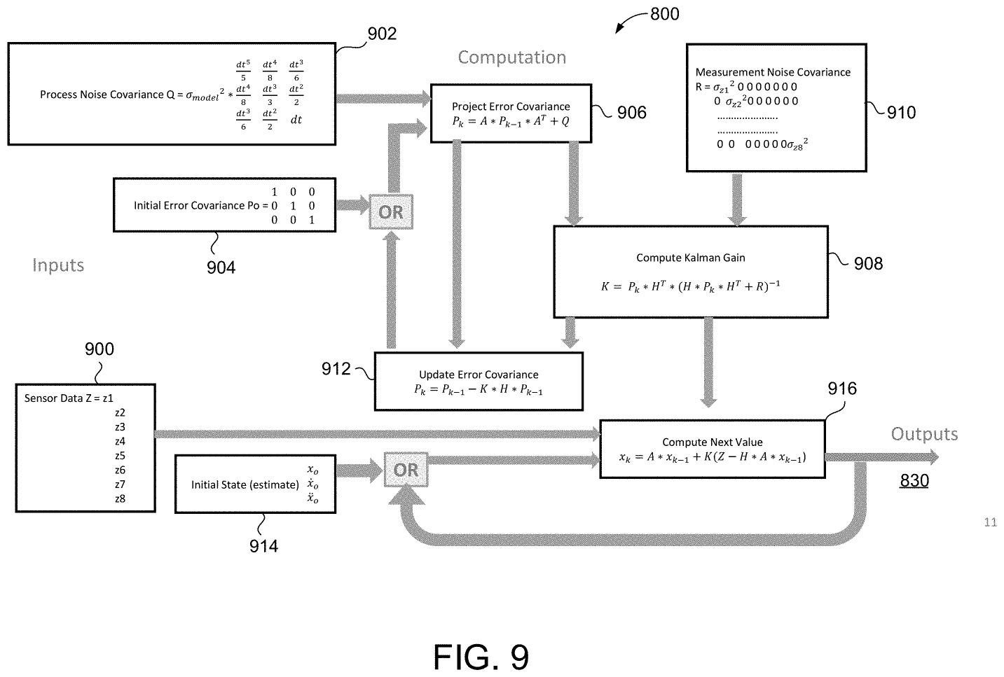

Referring now to FIG. 9, in some implementations, the multi-sensor filter 800 includes sensor data inputs 900 (e.g., from a plurality of sensors such as radar, cameras, etc.). The filter 800 may also include process noise covariance 902 and initial error covariance 904 which are processed to determine project error covariance at 906. The project error covariance may be used to determine Kalman gain 908 (along with measurement noise covariance 910). The Kalman gain and project error covariance together may determine an update error covariance 912 which provides feedback (along with the initial error covariance 904) to the project error covariance computation. The Kalman gain 908, along with the sensor data 900 and estimated initial state 914, in some examples, are used to compute the next value 916 of the filter 800. The result is the vehicle speed output 830.

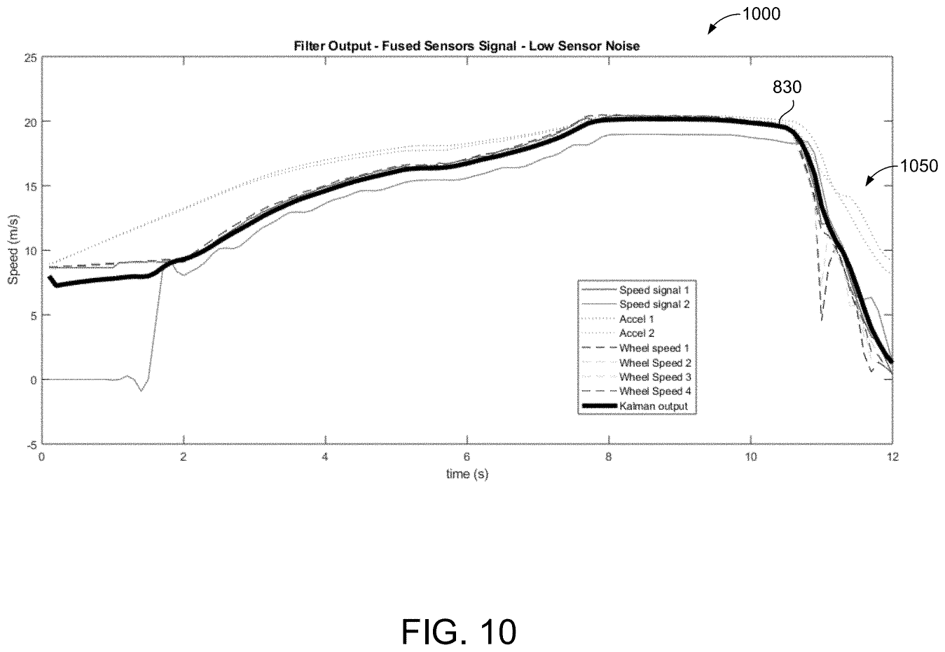

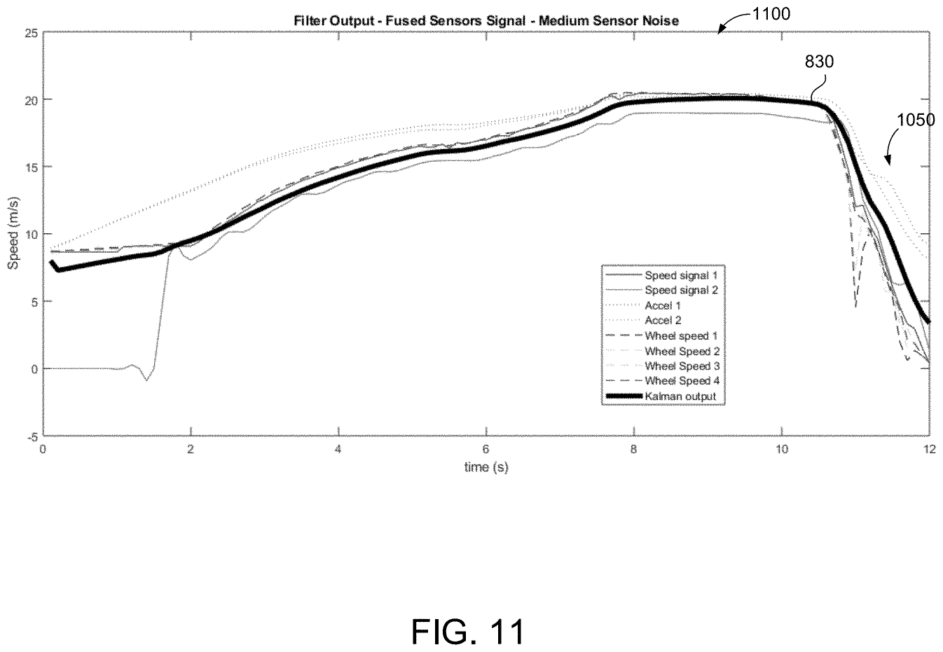

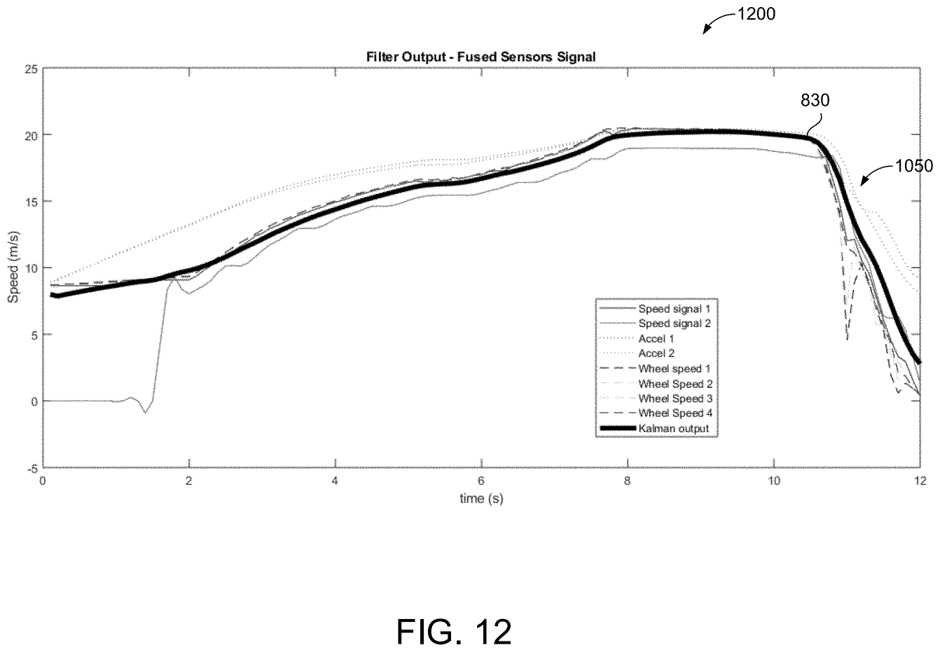

Referring now to FIGS. 10-12, plots 1000, 1100, 1200 illustrate filter output with low sensor noise (FIG. 10), medium sensor noise (FIG. 11), and high sensor noise (FIG. 12). The y-axis in each graph is speed (in meters per second) and the x-axis is time (in seconds). Despite the erratic sensor outputs during the strong braking event 1050, the filtered vehicle output speed 830 maintains an accurate value.

Thus, implementations herein provide a system for using multi-sensor fusion to fuse sensor data from a plurality of sensors to provide a filtered vehicle speed output. The filtered vehicle speed output resistant to erratic sensor data during strong braking events that otherwise may lead to erroneous velocity computations.

The vehicle may include any type of sensor or sensors, such as imaging sensors or radar sensors or lidar sensors or ultrasonic sensors or the like. The imaging sensor or camera may capture image data for image processing and may comprise any suitable camera or sensing device, such as, for example, a two dimensional array of a plurality of photosensor elements arranged in at least 640 columns and 480 rows (at least a 640×480 imaging array, such as a megapixel imaging array or the like), with a respective lens focusing images onto respective portions of the array. The photosensor array may comprise a plurality of photosensor elements arranged in a photosensor array having rows and columns. Preferably, the imaging array has at least 300,000 photosensor elements or pixels, more preferably at least 500,000 photosensor elements or pixels and more preferably at least 1 million photosensor elements or pixels. The imaging array may capture color image data, such as via spectral filtering at the array, such as via an RGB (red, green and blue) filter or via a red/red complement filter or such as via an RCC (red, clear, clear) filter or the like. The logic and control circuit of the imaging sensor may function in any known manner, and the image processing and algorithmic processing may comprise any suitable means for processing the images and/or image data.

For example, the vision system and/or processing and/or camera and/or circuitry may utilize aspects described in U.S. Pat. Nos. 9,233,641; 9,146,898; 9,174,574; 9,090,234; 9,077,098; 8,818,042; 8,886,401; 9,077,962; 9,068,390; 9,140,789; 9,092,986; 9,205,776; 8,917,169; 8,694,224; 7,005,974; 5,760,962; 5,877,897; 5,796,094; 5,949,331; 6,222,447; 6,302,545; 6,396,397; 6,498,620; 6,523,964; 6,611,202; 6,201,642; 6,690,268; 6,717,610; 6,757,109; 6,802,617; 6,806,452; 6,822,563; 6,891,563; 6,946,978; 7,859,565; 5,550,677; 5,670,935; 6,636,258; 7,145,519; 7,161,616; 7,230,640; 7,248,283; 7,295,229; 7,301,466; 7,592,928; 7,881,496; 7,720,580; 7,038,577; 6,882,287; 5,929,786 and/or 5,786,772, and/or U.S. Publication Nos. US-2014-0340510; US-2014-0313339; US-2014-0347486; US-2014-0320658; US-2014-0336876; US-2014-0307095; US-2014-0327774; US-2014-0327772; US-2014-0320636; US-2014-0293057; US-2014-0309884; US-2014-0226012; US-2014-0293042; US-2014-0218535; US-2014-0218535; US-2014-0247354; US-2014-0247355; US-2014-0247352; US-2014-0232869; US-2014-0211009; US-2014-0160276; US-2014-0168437; US-2014-0168415; US-2014-0160291; US-2014-0152825; US-2014-0139676; US-2014-0138140; US-2014-0104426; US-2014-0098229; US-2014-0085472; US-2014-0067206; US-2014-0049646; US-2014-0052340; US-2014-0025240; US-2014-0028852; US-2014-005907; US-2013-0314503; US-2013-0298866; US-2013-0222593; US-2013-0300869; US-2013-0278769; US-2013-0258077; US-2013-0258077; US-2013-0242099; US-2013-0215271; US-2013-0141578 and/or US-2013-0002873, which are all hereby incorporated herein by reference in their entireties. The system may communicate with other communication systems via any suitable means, such as by utilizing aspects of the systems described in International Publication Nos. WO 2010/144900; WO 2013/043661 and/or WO 2013/081985, and/or U.S. Pat. No. 9,126,525, which are hereby incorporated herein by reference in their entireties.

The system may utilize sensors, such as radar or lidar sensors or the like. The sensing system may utilize aspects of the systems described in U.S. Pat. Nos. 9,753,121; 9,689,967; 9,599,702; 9,575,160; 9,146,898; 9,036,026; 8,027,029; 8,013,780; 6,825,455; 7,053,357; 7,408,627; 7,405,812; 7,379,163; 7,379,100; 7,375,803; 7,352,454; 7,340,077; 7,321,111; 7,310,431; 7,283,213; 7,212,663; 7,203,356; 7,176,438; 7,157,685; 6,919,549; 6,906,793; 6,876,775; 6,710,770; 6,690,354; 6,678,039; 6,674,895 and/or 6,587,186, and/or International Publication Nos. WO 2018/007995 and/or WO 2011/090484, and/or U.S. Publication Nos. US-2018-0231635; US-2018-0045812; US-2018-0015875; US-2017-0356994; US-2017-0315231; US-2017-0276788; US-2017-0254873; US-2017-0222311 and/or US-2010-0245066, which are hereby incorporated herein by reference in their entireties.

Changes and modifications in the specifically described embodiments can be carried out without departing from the principles of the invention, which is intended to be limited only by the scope of the appended claims, as interpreted according to the principles of patent law including the doctrine of equivalents.

1. A vehicular driving assist system, the vehicular driving assist system comprising:
a plurality of vehicle speed sensors disposed at a vehicle, each of the vehicle speed sensors generating an output representative of a respective speed of the vehicle;
wherein the plurality of vehicle speed sensors comprises at least two selected from the group consisting of (i) at least one vehicle wheel angular velocity sensor of a driven vehicle wheel of the vehicle, (ii) at least one vehicle wheel angular velocity sensor of a non-driven vehicle wheel of the vehicle, (iii) at least one inertial measurement unit of the vehicle and (iv) at least one GPS sensor of the vehicle;
a control comprising circuitry and associated software; and
wherein the circuitry of the control comprises a processor for processing the outputs of the plurality of vehicle speed sensors to determine a current speed of the vehicle.

2. The vehicular driving assist system of claim 1, wherein each vehicle speed sensor output is weighted based on an accuracy rating of the respective vehicle speed sensor.

3. The vehicular driving assist system of claim 1, wherein each vehicle speed sensor output is weighted based on a level of noise in the output of the respective vehicle speed sensor.

4. The vehicular driving assist system of claim 1, wherein the plurality of vehicle speed sensors comprises a vehicle wheel angular velocity sensor of a non-driven vehicle wheel of the vehicle.

5. The vehicular driving assist system of claim 1, wherein the plurality of vehicle speed sensors comprises a vehicle wheel angular velocity sensor of a driven vehicle wheel of the vehicle.

6. The vehicular driving assist system of claim 1, wherein the plurality of vehicle speed sensors comprises a vehicle wheel angular velocity sensor of a non-driven vehicle wheel of the vehicle and a vehicle wheel angular velocity sensor of a driven vehicle wheel of the vehicle.

7. The vehicular driving assist system of claim 1, wherein the plurality of vehicle speed sensors comprises at least three selected from the group consisting of (i) at least one vehicle wheel angular velocity sensor of a driven vehicle wheel of the vehicle, (ii) at least one vehicle wheel angular velocity sensor of a non-driven vehicle wheel of the vehicle, (iii) at least one inertial measurement unit of the vehicle and (iv) at least one GPS sensor of the vehicle.

8. The vehicular driving assist system of claim 1, wherein the plurality of vehicle speed sensors comprises (i) at least one vehicle wheel angular velocity sensor of a driven vehicle wheel of the vehicle, (ii) at least one vehicle wheel angular velocity sensor of a non-driven vehicle wheel of the vehicle, (iii) at least one inertial measurement unit of the vehicle and (iv) at least one GPS sensor of the vehicle.

9. The vehicular driving assist system of claim 1, wherein the plurality of vehicle speed sensors comprises (i) a vehicle wheel angular velocity sensor of each driven vehicle wheel of the vehicle, (ii) a vehicle wheel angular velocity sensor of each non-driven vehicle wheel of the vehicle and (iii) a GPS sensor of the vehicle.

10. The vehicular driving assist system of claim 1, wherein the plurality of vehicle speed sensors comprises (i) a vehicle wheel angular velocity sensor of a non-driven vehicle wheel, (ii) a vehicle wheel angular velocity sensor of a driven vehicle wheel and (iii) a GPS sensor of the vehicle.

11. The vehicular driving assist system of claim 1, wherein the control uses a multi-sensor filter in determining the current vehicle speed.

12. The vehicular driving assist system of claim 11, wherein the control conditions the outputs of the plurality of vehicle speed sensors prior to filtering the outputs of the plurality of vehicle speed sensors with the multi-sensor filter.

13. The vehicular driving assist system of claim 11, wherein the multi-sensor filter comprises a Kalman filter.

14. A vehicular driving assist system, the vehicular driving assist system comprising:
a plurality of vehicle speed sensors disposed at a vehicle, each of the vehicle speed sensors generating an output representative of a respective speed of the vehicle;
wherein the plurality of vehicle speed sensors comprises (i) at least one vehicle wheel angular velocity sensor of a driven vehicle wheel of the vehicle and (ii) at least one vehicle wheel angular velocity sensor of a non-driven vehicle wheel of the vehicle;
a control comprising circuitry and associated software;
wherein the circuitry of the control comprises a processor for processing the outputs of the plurality of vehicle speed sensors to determine a current speed of the vehicle; and
wherein the control uses a multi-sensor filter to determine a single filtered current vehicle speed based on the outputs of the plurality of vehicle speed sensors.

15. The vehicular driving assist system of claim 14, wherein the plurality of vehicle speed sensors further comprises at least one inertial measurement unit of the vehicle.

16. The vehicular driving assist system of claim 14, wherein the plurality of vehicle speed sensors further comprises a GPS sensor of the vehicle.

17. The vehicular driving assist system of claim 14, wherein the control conditions the outputs of the plurality of vehicle speed sensors prior to filtering the outputs of the plurality of vehicle speed sensors with the multi-sensor filter.

18. The vehicular driving assist system of claim 14, wherein the multi-sensor filter comprises a Kalman filter.

19. A vehicular driving assist system, the vehicular driving assist system comprising:
a plurality of vehicle speed sensors disposed at a vehicle, each of the vehicle speed sensors generating an output representative of a respective speed of the vehicle;
wherein the plurality of vehicle speed sensors comprises (i) a vehicle wheel angular velocity sensor at each driven vehicle wheel of the vehicle, (ii) a vehicle wheel angular velocity sensor at each non-driven vehicle wheel of the vehicle, and (iii) a GPS sensor of the vehicle;
wherein each vehicle speed sensor output is weighted based on a level of noise in the output of the respective vehicle speed sensor;
a control comprising circuitry and associated software; and
wherein the circuitry of the control comprises a processor for processing the weighted outputs of the plurality of vehicle speed sensors to determine a current speed of the vehicle.

20. The vehicular driving assist system of claim 19, wherein the weight of a first vehicle speed sensor of the plurality of vehicle speed sensor is greater than a weight of a second vehicle speed sensor of the plurality of vehicle speed sensors when the noise in the output of the first vehicle speed sensor is less than the noise in the output of the second vehicle speed sensor.

21. The vehicular driving assist system of claim 19, wherein the plurality of vehicle speed sensors further comprises at least one inertial measurement unit of the vehicle.

22. The vehicular driving assist system of claim 19, wherein the control uses a multi-sensor filter in determining the current vehicle speed.

23. The vehicular driving assist system of claim 22, wherein the control conditions the outputs of the plurality of vehicle speed sensors prior to filtering the outputs of the plurality of vehicle speed sensors with the multi-sensor filter.

24. The vehicular driving assist system of claim 22, wherein the multi-sensor filter comprises a Kalman filter.
